(19) United States
(12) Patent Application Publication
(10) Pub. No.: US 2015/0262386 A1
(43) Pub. Date: Sep. 17, 2015

(54) SYSTEMS AND METHODS FOR STREAMING GRAPHICS ACROSS A NETWORK

(71) Applicant: LEAP Computing, Inc., Austin, TX (US)

(72) Inventor: Frank Joshua Alexander Nataros, Austin, TX (US)

(21) Appl. No.: 14/656,924

(22) Filed: Mar. 13, 2015

Related U.S. Application Data
(60) Provisional application No. 61/953,386, filed on Mar. 14, 2014.

(51) Int. Cl. G06T 11/00; G06T 11/40; G06T 1/60; G06T 15/04; G06T 15/00

(52) U.S. Cl. CPC G06T 11/001; G06T 15/04; G06T 15/005; G06T 1/60; G06T 11/40

(57) ABSTRACT

A method for streaming graphics, that includes determining, with a first process, the location of a back buffer of a second process, wherein the back buffer stores rendered graphics of the second process, and wherein the first and second processes run on a server. The method further includes copying at least a portion of the rendered graphics from the back buffer, thereby generating a rendered graphics copy and applying the rendered graphics copy to a flat two-dimensional (2D) object, thereby generating a textured object. The method further includes encoding the textured object into a video stream compatible with being transmitted over a network, and transmitting the video stream from the server to a client device via a network.

### CROSS-REFERENCE TO RELATED APPLICATIONS

The present application claims the benefit of U.S. Provisional Application No. 61/953,386, filed Mar. 14, 2014, entitled “LEAP Computing direct-app hook method,” all of which is incorporated therein by reference.

### TECHNICAL FIELD

The present disclosure relates to streaming graphics across a network and, in particular, determining the location of a back buffer and reading memory directly therefrom for encoding and transfer, thereby enabling increasing efficiency.

### BACKGROUND

Technology now requires nearly every device to include a display and be capable of processing graphics and video data, at least to some extent. A problem arises, however, with the reduced size in portable electronics (e.g., laptop computers, tablet computers, and cell phones) resulting in limited functionality that can be included with the processor and/or device overall.

This problem is highly prevalent with games run on such devices. A typical desktop gaming machine may include a graphics card that has large amounts of memory and one or more specialized graphics processing units (GPUs) specifically designed to handle a high volume of intense graphics processing. However, such graphics cards typically requires a large amount of physical space and further require substantial power from the computer bus (some even requiring an additional or external power supply). Thus, such graphics cards are impractical for small portable electronics.

One solution to this problem is offloading the graphics processing to computers and servers external to the portable electronic device. Further solutions include completely offloading the entire game (or program requiring intense graphics processing) to the server, whereby the server merely receives control commands from the mobile device, runs the program and performs the graphics processing, and then returns the processed graphics to the mobile device for display.

The problem now presented is one of “lag” due to a variety of reasons. One such reason may be the inherent inability of the processing computer software configuration to process and output such graphics in a fashion fast enough for the resulting graphics to appear smooth when displayed on the mobile device.

Other reasons may be the numerous software processes required prior to the graphics being transmitted to the portable electronic. For example, the server runs a program which makes a graphics call request, this request is then processed by the graphics API which likely interacts with a GPU to actually process the graphics. A completed graphics frame is loaded into the programs back buffer. The operating system must then obtain the completed graphic from the back buffer, and employ another program to transmit the graphic. Such numerous processes and programs employed highly reduce the speed at which graphics can be output to the mobile device, thus causing “lag”.

Lastly, high overhead on the portable electronics may still be required to interact with the remote server and process the incoming graphics feed.

Accordingly, improved systems and methods which require low overhead on a portable device, yet are capable of transferring processed graphics data for a smooth presentation on the portable device remains highly desirable.

### SUMMARY OF THE INVENTION

The present disclosure introduces various illustrative embodiments for streaming graphics across a network and, in particular, determining the location of a back buffer and reading memory directly therefrom for encoding and transfer, thereby enabling increasing efficiency.

It is an object of the present disclosure to provide a method for streaming graphics, which includes determining, with a first process, the location of a back buffer of a second process, wherein the back buffer stores rendered graphics of the second process, and wherein the first and second processes run on a server. The method further includes copying at least a portion of the rendered graphics from the back buffer, thereby generating a rendered graphics copy and applying the rendered graphics copy to a flat two-dimensional (2D) object, thereby generating a textured object. The method further includes encoding the textured object into a video stream compatible with being transmitted over a network, and transmitting the video stream from the server to a client device via a network.

It is another object of the present disclosure to provide a non-transitory computer-readable medium with instructions that, when executed by a processor, cause the processor to perform operations for streaming graphics that include determining, with a first process, the location of a back buffer of a second process, wherein the back buffer stores rendered graphics of the second process, and wherein the first and second processes run on a server. The instructions further cause the processor to copy at least a portion of the rendered graphics from the back buffer, thereby generating a rendered graphics copy and apply the rendered graphics copy to a flat two-dimensional (2D) object, thereby generating a textured object. The instructions further cause the processor to encode the textured object into a video stream compatible with being transmitted over a network, and transmit the video stream from the server to a client device via a network.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is a system for streaming graphics, according to one or more embodiments.

FIG. 2 is a block diagram of the computer(s) of the server system, according to one or more embodiments.

FIG. 3 is a flow diagram of an illustrative method for performing graphics streaming, according to one or more embodiments.

### DETAILED DESCRIPTION

The present disclosure relates to streaming graphics across a network and, in particular, determining the location of a back buffer and reading memory directly therefrom for encoding and transfer, thereby enabling increasing efficiency.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

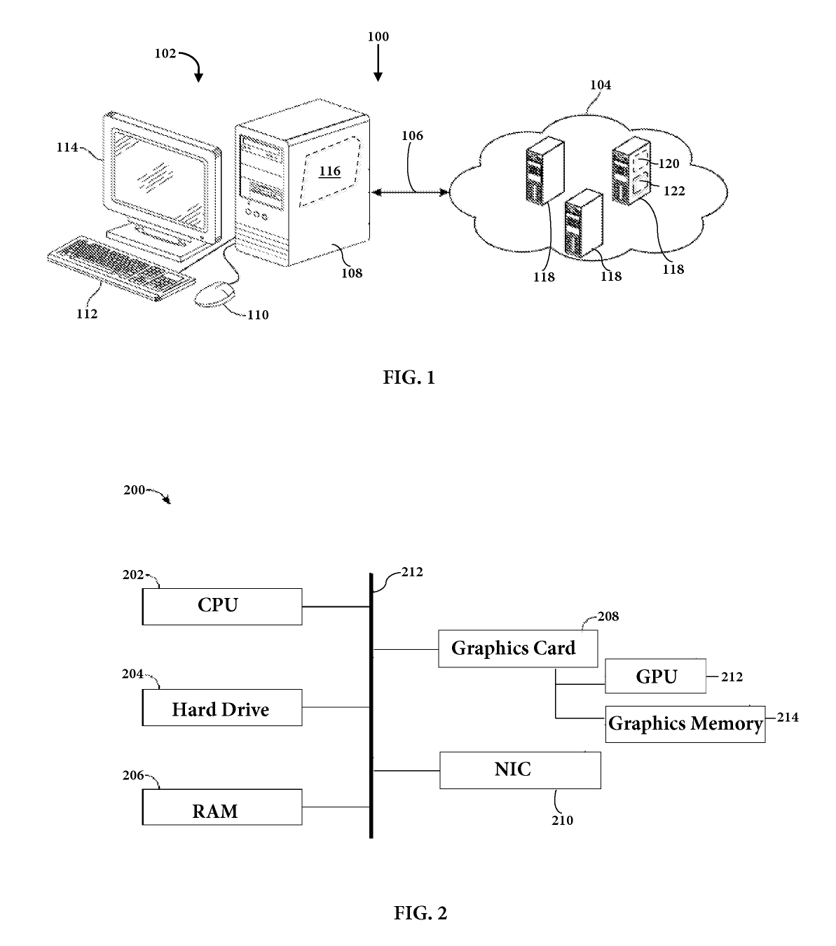

FIG. 1 depicts a system 100 for streaming graphics, according to one or more embodiments. The system 100 includes a client system 102 communicably coupled to various input and output devices (I/O) for a user to interact with, and a server system 104 communicably coupled to the client system 102 via a network 106 to receive the I/O, run processes and programs, and stream graphics back to the client system 102 for display.

More specifically, in some embodiments, and as depicted, the client system 102 includes a computer 108 communicably coupled to I/O devices, such as a mouse 110 and keyboard 112. The computer 108 may further be coupled to additional I/O devices, such as a display screen or monitor 114. One of skill in the art will appreciate that alternative embodiments of the client system 102 may be, for example and without limitation, any variety of electronics, and especially those employed for game playing (e.g., laptop computers, tablet computers, cell phones, portable and/or non-portable video game devices and consoles). Thus, the components of client system 102 (e.g., the computer 108, keyboard 112, mouse 110, and monitor 114) need not all be present and/or may be combined or integrated together into a single unit or device. Further alternative embodiments contemplated herein include where the client system 102 is simply a “terminal” as known to those skilled in the art. The client system 102 further includes a client program 116 run on the computer 108 for interacting with the server system 104 via the network 106.

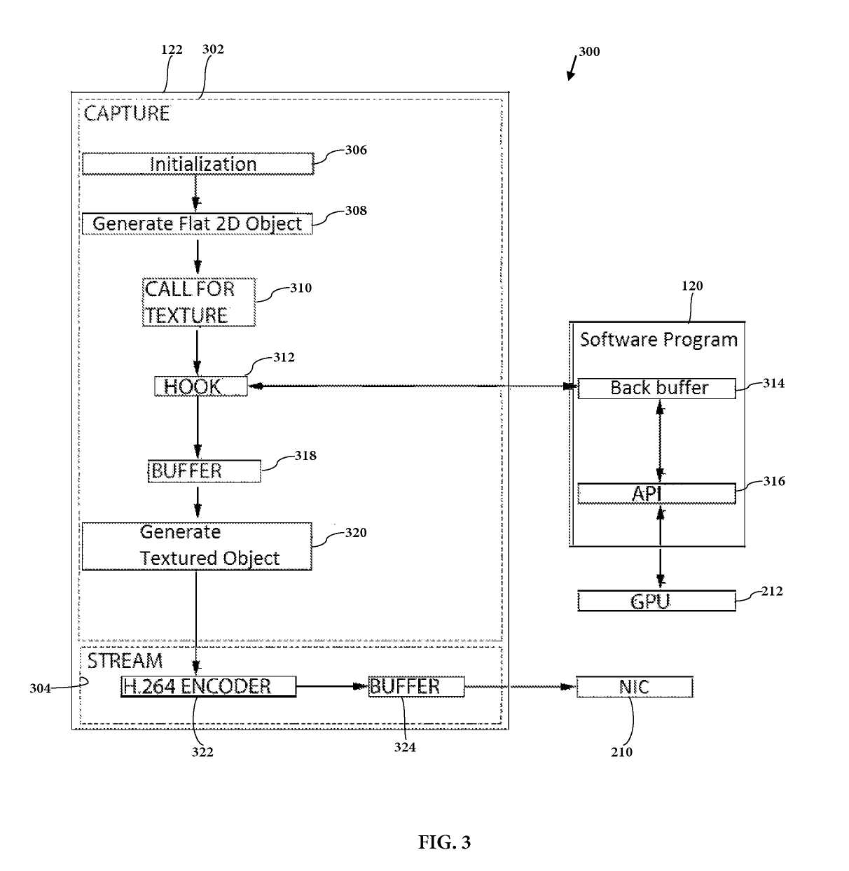

The server system 104 is comprised of one or more computers 118. The computer 118, discussed in more detail in FIG. 3 below, includes and executes a software program or process 120 which generates graphic images that are processed by the computer 118. For example, the software process 120 may simply be the operating system, or may be a graphic intensive program such as a game or graphics rendering program (e.g., Adobe Photoshop). As discussed above, one problem which plagues portable devices is their reduced size, and thus limited space for high-end image and graphics processing hardware. Therefore, such processing may be offloaded to the server system 104, including in some embodiments, offloading an entire game to be run on the server system 104, thereby leaving the client system 102 to only require the ability to handle the I/O and streaming requirements, but not the graphics processing.

Thus, in some embodiments, the server system 104 computer(s) 118 may include specialized central processing units (CPUs) with integrated graphics processing unit (GPUs), separate GPUs, or even specialized graphics cards which include one or more GPUs and memory for expedited graphics processing. In other embodiments, the software process 120 may be any general program, including the operating system itself (for example, when a user wants to view (stream) the entire desktop of the server system 104 to the client system 102). The computer 118 additionally includes a graphics streaming program or process 122 which, among other things, communicates with the client system 102, including receiving I/O communications (such as mouse 110 and keyboard 112 commands) and intercepts and transmits processed graphics from software process 120 (discussed in detail below).

In further embodiments, the network 106 can be any variety of LAN, WAN, or the like as known to those skilled in the art capable of transferring data between the client system 102 and the server system 104. The network 106 can include a variety of hard-wired and/or wireless connections or nodes, including mobile telephone networks.

In exemplary operation, the client program 116 is executed by the client system 102. Client program 116 collects inputs from the user, for example, through the keyboard 112 and mouse 110 I/O. Program 116 communicates these inputs to the server system 104 via the network 106. The server system 104 is running the software process 120 as desired by the user. The server system is further running the graphics streaming program 122 for communicating with the client system 102 and intercepting and processing the graphics calls from the software process 120.

Typically, upon the software process 120 producing rendered graphics, the operating system waits until a buffer is filled and then obtains the rendered graphics for output. However, when streaming across a network, the operating system must then employ, and transfer the graphics to a third software or process for transmission. The third software then encodes the graphics and transfers them to the client system 102. However, as described herein, the present disclosure advantageously provides increased speed in ability to obtain the rendered graphics directly from a back buffer of the software process 120 memory, and thus bypasses calls by the operating system and/or additional third software, and directly transmits the rendered graphics to the client system 102. Such a bypass increases both speed and efficiency as described in further detail below.

FIG. 2 is a block diagram 200 of the computer(s) 118 of the server system 104, according to one or more embodiments. As depicted, the computer 118 may include a central processing units (CPU) 202, a hard drive 204, RAM 206, a graphics card 208, and a network interface card (NIC) 210. Moreover, all of the aforementioned components may be electrically and/or communicably coupled via one or more buses 212.

The central processing unit (CPU) 202 may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art. Thus, the CPU 202 may be comprised of a CPU and an accelerated processing unit (APU) or graphics processing unit (GPU), thereby enabling increased ability to perform graphics processing locally.

The computer 118, as depicted in diagram 200, further includes various types of memory, such as hard drive 204 and RAM 206. Hard drive 204 may be any type of memory known to those skilled in the art capable of storing data or executable instructions thereon for a prolonged period of time, and continuing to store such should power to the computer 118 be turned off. Examples of such include, without limitation, all variations of non-transitory computer-readable hard disk drives, inclusive of solid-state drives. Other embodiments of the computer 118 may further include random access memory (RAM) 206. RAM 206 may be external to computer 118, or in other embodiments be internal (e.g., local RAM or “on-board” memory) to computer 118, and work in coordination with hard drive 204 to store and/or execute programs (e.g., software program 120 and/or graphic streaming program 122) and/or process graphics data, etc. Example embodiments of RAM may include, without limitation, volatile or non-volatile memory, DDR memory, Flash Memory, EPROM, ROM, or various other forms, or any combination thereof generally known as memory or RAM.

In further embodiments, the computer 118 includes graphics card 208 for assisting with graphics processing, especially intensive graphics processing. The graphics card 208 may include one or more GPUs 212 (also known as, or alternatively employed as an accelerated processing units (APUs)) specially designed to process graphics. The graphics card 208 typically further includes dedicated on-board graphics memory 214 reserved for use with the graphics card GPUs 212. Drivers and/or a graphics card API may be stored and executed from the CPU 202, hard drive 204, and RAM 206. The graphics card 208, when included in the computer 118, works in combination with the CPU 202, hard drive 2104, and RAM 206 to process graphics from programs such as the software program 120 and/or graphic streaming program 122, thereby freeing CPU 202, hard drive 204, and/or RAM 206 resources for running other processes.

In other embodiments, the computer 118 further includes a NIC 210. The NIC 210 enables communication over any variety of network, and in any form as known to those skilled in the art. For example, the network may be a LAN or WAN network, and the communication may be via wired and/or wireless (including cellular communications) technologies and protocols. Example communications may be between various computers 118 of the server system 104, and/or between the server system 104 and the client system 102.

FIG. 3 is a flow diagram of an illustrative method 300 for performing graphics streaming, according to one or more embodiments. In sum, the method 300 includes the graphics streaming program 122 which interacts with the software program 120 (which is generating the rendered frames) via a “hook”, thereby enabling obtainment of rendered frames by the graphics streaming program 122 without interaction by the operating system or other programs or processes. Thereafter, additional processing may be performed and the rendered frames are output via the NIC 210 to the client system 102 (FIG. 1). Such may be processed and/or executed by one or more embodiments discussed and described herein, such as the system 100 and diagram 200.

The graphics streaming program 122 and the software program 120 are executed by one or more servers which communicate with, and output the rendered frames to a client system 102 (FIG. 1) via the NIC 210 across a network. In some embodiments, the servers may be a single or multiple computers within a room or building. In other embodiments, the servers may be in the form of a cloud computer or cloud computing network as known to those skill in the art. In some embodiments, the method 300 further obtains input from a user of the client device (e.g., keyboard and/or mouse, etc.) and transfers these inputs to the software program 120 for inclusion and processing. Such may be employed, for example, for a user to send control commands to the software program 120 when executing a game. The method 300 may be implemented and/or performed by one or more of the embodiments discussed above.

As depicted, the graphics streaming program includes a “capture” 302 portion focused on finding and obtaining the rendered frames of the software program 120, and a “stream” portion 304 which thereafter handles encoding and outputting frames to the NIC 120 for transmission to the client system 102. However, one of skill in the art will appreciate the nomenclature (capture 302 and stream 304) to be for illustrative purposes only, and neither required nor represent specific routines or subroutines of execution.

In some embodiments, as at block 306, the graphics streaming software 122 may perform initialization tasks. For example, the graphics streaming software 122 may begin running and wait for a program or process which require graphics to begin (e.g. wait for the software program 120 to begin). In further embodiments, the graphics streaming software 122 may also create a graphics instance (e.g., initiate a graphics rendering API, such as Direct3D (D3D), DirectX, OpenGL (typically on linux)).

In further embodiments, as at block 308, upon the software program 120 beginning, the graphics streaming software 122 renders a flat two-dimensional (2D) object using the graphics instance previously created (e.g., D3D, DirectX, etc.). Typically, the flat 2D object is the same or substantially the same size as the window which the software program 120 is running in. However, in alternative embodiments, the flat 2D object may be the size of the entire screen, for example, if the software program is a game running in “full screen” mode. In further embodiments, the flat 2d object may be scaled in size as preferred or necessary. After generating the flat 2D object, in other embodiments, as at block 310, the method 300 may “call for texture” or employ the graphics API to locate a frame to be applied as a texture to the flat 2D object.

In obtaining the texture to be applied, the method 300 employs a direct link to the software program's 120 back buffer 314 via a hook 312. As known to those skilled in the art, when a program executes (e.g. software program 120 begins execution), the software program 120 employs the graphics rendering software API 316 to, among many other tasks, create a memory space for storing rendered graphics. This memory space is typically referred to as a back buffer 314. Some embodiments may include a GPU 212, for example, where a graphics card is employed with the server where the software program 120 is running In such a case, the API 316 typically also interacts between the GPU 212 processing and rendering the frames, and the back buffer 314 memory where they will be stored.

The hook 312 determines the location of the back buffer, and, in some embodiments, keeps track of the back buffer 314 and associated pointers. In one embodiment, such is accomplished via predetermined rules which control allocation of the back buffer 314. In other words, the graphics streaming program 122 includes predetermined rules that control the allocation of the back buffer 314. Such may be, for example and without limitation, control of the GPU 212 memory, and rules regarding request/allocation and release of memory, and memory allocation block size. In alternative embodiments, the graphics streaming program 122 may perform a partial or full scan of the memory, and determine from such scan where the back buffer 314 is allocated. In further embodiments, the graphics API may be employed to assist or fully determine where the back buffer 314 is allocated.

Upon determination of the back buffer location, the hook 312 is capable of continuously obtains rendered graphics from the back buffer 314 while the software program 120 is running The obtained rendered graphics may be applied to the flat 2D object, thereby generating a textured object, as at block 320. However, in some embodiments, the method 300 may store a portion or all of the obtained rendered graphics in a second buffer prior to applying the rendered graphics to the flat 2D object, thereby generating a rendered graphics copy stored in the second buffer, as at block 318. Such may be advantageous, or even required, for various reasons. For example, such may be advantageous to keep stored information about the frames (e.g., if they are stored in a raw format or not; what format the frame is (e.g., bitmap, jpg., etc.), and/or to identify or define what information is in the back buffer 314).

Alternatively, such may be required if further processing is necessary on the rendered graphics before it can be used in combination with the flat 2D object to generate the textured object at block 320. For example, the back buffer may store the rendered frame in a first format (e.g. a bitmap) which isn't supported, therefore the rendered frame must be converted into a second format (e.g., a jpg) which is supported and then stored (or re-stored) in the second buffer 318. Various frame headers may also be added or removed, and the result stored in the buffer 318.

In further embodiments, as at block 322, the textured object is encoded via any applicable encoding process know to those skilled in the art, thereby becoming a “video stream” compatible with being transmitted over the network 106 from the server system 104 to the client system 102. Notably, as one of skill in the art will appreciate, and as used herein, a “video stream” may be comprised of one or more encoded textured objects or images. One example of a well-known encoding and compression format is H.264. Such encoding is preferably performed in hardware, for example and without limitation, employing AMD or nVidia graphics cards or an Intel processor, thereby enabling the server processors and memory to remain free for other tasks. However, encoding via software may alternatively take place.

The video stream is capable of being transmitted over the network via the NIC 210, but in some embodiments, may first be stored in a third buffer prior to transmission, as at block 324. Afterwards, the video stream is transmitted via the NIC 210 from the server system (e.g. server system 104) to the client system (e.g., client system 102) for display thereon.

With present day systems, after graphics are stored in the back buffer 314, they are transferred to a front buffer, where they are then obtained by the operating system for output (or for encoding and transmission to other computers via additional processes). Due to the multiple memory copies and transfers, and multiple programs involved in the operation, a “lag” is created between time the graphics are rendered and time they are transferred across the network to the user (e.g., client system 102), thus degrading the users visual experience, and possibly rendering some programs (especially games) impossibly to play.

However, as disclosed and discussed herein, advantageously, a direct feed or hook 312 to the back buffer enables circumvention of the multiple and various processes typically employed, and enables a near-direct feed of rendered graphics from the back buffer 314 out to the NIC 210 and to the client system 102, thereby increasing the speed at which frames can be transferred and creating an enhanced visual appearance for the user at the client system. As discussed above and described herein, it is clear that such tasks are not manually possible, specialized software is required to find and maintain a direct link to the back buffer 314, and specialized hardware (graphics card 208, GPU 212, and graphics memory 214) is typically advantageous to have in combination with the computers 118 of the server system 104 as well. Such a direct link to the back buffer 314 by a program other than the software program 120 and/or graphics API 316 is unconventional, novel, and unique, and improves the functionality of the computer by increasing the speed at which graphics can be output to the NIC 210, and thus providing a faster and smoother video image at the client system 102.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

While methods are described in terms of “comprising,” “containing,” or “including” various components or steps, the methods can also “consist essentially of” or “consist of” the various components and steps. Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

What is claimed is:

1. A method for streaming graphics, comprising:
determining, with a first process, the location of a back buffer of a second process, wherein said back buffer stores rendered graphics of said second process, and wherein said first and second processes run on a server;
copying at least a portion of said rendered graphics from said back buffer, thereby generating a rendered graphics copy;
applying said rendered graphics copy to a flat two-dimensional (2D) object, thereby generating a textured object;
encoding said textured object into a video stream compatible with being transmitted over a network; and
transmitting said video stream from said server to a client device via a network.

2. The method of claim 1, wherein said determining the location of said back buffer is performed via predetermined rules which control allocation of said back buffer.

3. The method of claim 1, wherein said determining the location of said back buffer is performed via a scan of a memory.

4. The method of claim 1, wherein said determining the location of said back buffer is performed, at least in part, by employing the graphics API.

5. The method of claim 1, further comprising rendering said flat 2D object of substantially the same frame size as required by said rendered graphics prior to said copying at least a portion of said rendered graphics from said back buffer.

6. The method of claim 1, further comprising rendering said flat 2D object of a scaled size to said rendered graphics prior to said copying at least a portion of said rendered graphics from said back buffer.

7. The method of claim 1, further comprising:
altering at least a portion of said rendered graphics copy; and
storing said altered rendered graphics copy into a second buffer prior to applying said rendered graphics copy to a flat 2D object.

8. The method of claim 1, further comprising, copying at least a portion of said video stream into a third buffer prior to transmission over said network.

9. The method of claim 1, wherein the server is a cloud computing network.

10. The method of claim 1, further comprising:
obtaining input from the client device; and
transferring said input to said second process.

11. A non-transitory computer-readable medium with instructions that, when executed by a processor, cause said processor to perform operations for streaming graphics comprising:
determining, with a first process, the location of a back buffer of a second process, wherein said back buffer stores rendered graphics of said second process, and wherein said first and second processes run on a server;
copying at least a portion of said rendered graphics from said back buffer, thereby generating a rendered graphics copy;
applying said rendered graphics copy to a flat two-dimensional (2D) object, thereby generating a textured object;
encoding said textured object into a video stream compatible with being transmitted over a network; and
transmitting said video stream from said server to a client device via a network.

12. The non-transitory computer-readable medium of claim 11, wherein said determining the location of said back buffer is performed via predetermined rules which control allocation of said back buffer.

13. The non-transitory computer-readable medium of claim 11, wherein said determining the location of said back buffer is performed via a scan of a memory.

14. The non-transitory computer-readable medium of claim 11, wherein said determining the location of said back buffer is performed, at least in part, by employing the graphics API.

15. The non-transitory computer-readable medium of claim 11, wherein said instructions further cause said processor to render said flat 2D object of substantially the same frame size as required by said rendered graphics prior to said copying at least a portion of said rendered graphics from said back buffer.

16. The non-transitory computer-readable medium of claim 11, wherein said instructions further cause said processor to render said flat 2D object of a scaled size to said rendered graphics prior to said copying at least a portion of said rendered graphics from said back buffer.

17. The non-transitory computer-readable medium of claim 11, wherein said instructions further cause said processor to:
alter at least a portion of said rendered graphics copy; and
store said altered rendered graphics copy into a second buffer prior to applying said rendered graphics copy to a flat 2D object.

18. The non-transitory computer-readable medium of claim 11, wherein said instructions further cause said processor to copy at least a portion of said video stream into a third buffer prior to transmission over said network.

19. The non-transitory computer-readable medium of claim 11, wherein the server is a cloud computing network.

20. The non-transitory computer-readable medium of claim 11, wherein said instructions further cause said processor to:
obtain input from the client device; and
transfer said input to said second process.
